(19) United States
(12) Patent Application Publication
(10) Pub. No.: US 2013/0030947 A1
(43) Pub. Date: Jan. 31, 2013

(54) NETWORK STRUCTURE AND METHOD OF ITS USE FOR DISTRIBUTING AND MAINTAINING PROVISIONING INFORMATION BETWEEN A NETWORK MARKETPLACE AND ONE OR MORE VENDORS FOR THE PURPOSE OF REGISTERING, INSTALLING AND CONFIGURING SOLUTIONS AND PRODUCTS

(71) Applicants: Christian Dreke, Portland, OR (US); Gregory A. Kim, Happy Valley, OR (US)

(72) Inventors: Christian Dreke, Portland, OR (US); Gregory A. Kim, Happy Valley, OR (US)

(73) Assignee: ACCUMULUS CORPORATION, Portland, OR (US)

(21) Appl. No.: 13/560,676

(22) Filed: Jul. 27, 2012

Related U.S. Application Data
(60) Provisional application No. 61/512,300, filed on Jul. 27, 2011.

(51) Int. Cl. G06Q 30/00

(52) U.S. Cl. 705/26.5

(57) ABSTRACT

Disclosed is a method and structure for provisioning information within a network which employs an intermediary, such as an intermediary provisioning server, to automatically distribute and maintain provisioning information between network components such as marketplace and vendor server computers and customers.

### CROSS-REFERENCE TO RELATED APPLICATIONS

This application claims priority from U.S. provisional patent application Ser. No. 61/512,300, filed Jul. 27, 2011.

### BACKGROUND OF THE INVENTION

The present invention pertains to distributing and maintaining provisioning information. More particularly, the present invention pertains to a server assisted network and provisioning method for registering, configuring, and installing applications, modules or services within an online marketplace.

A network may be defined as a group of connected computers that allows systems to share information and equipment. For example, a server to server network may consist of one or more server computers connected to each other via standard Internet protocols such as TCP/IP. Organizations (also referred to herein as “vendors,” or “marketplaces”) may use their servers to communicate and exchange information with each other across organizational boundaries securely via standard Internet protocols such as TCP/IP and HTTPS. In addition to allowing organizations to share information via their servers communicating with each other directly, current network technology (such as the Internet) permits an exchange of information between organizations connected to said network via servers through 3rd party intermediaries (also referred to as “intermediaries”).

In addition to offering their own applications, modules, or services (also referred to as “the product”), a marketplace vendor may offer 3rd party products from one or more other vendors to its customers through its online marketplace. Customers purchasing said products may do so exclusively via said marketplace store. Purchases by said customers may be of a recurring nature where said customers are billed periodically for said products. After purchase of a product by said customer, said product must often be provisioned in order to be delivered and made accessible to said customer. This is particularly important where the product connects to other products purchased by said customer through said marketplace.

However, because the set of products available within the marketplace is dynamic in nature and it is unlikely those different products have the same provisioning requirements, marketplace vendors face significant burdens to offer 3rd party products.

Accordingly, there is a need for a method which will scalably provision marketplace and 3rd party products for customers purchasing said products through said marketplace.

### SUMMARY OF THE INVENTION

A computer system for disseminating product provisioning information provided by two or more vendors to at least one customer via a marketplace and an associated intermediary provisioning server, said system comprising a marketplace offering at least two products for distribution to at least one customer; an intermediary provisioning server; and software recorded on a computer-readable medium enabling the intermediary provisioning server to perform the steps of receiving a message from the marketplace containing customer specific values for provisioning one or more said products requested by said customer and provided by a said vendor, in response to said message, transmitting a message to said vendor including a globally unique provisioning identification code, and receiving from said vendor a message containing said globally unique provisioning identification code and a message indicating a provisioning completion status.

The foregoing and other objectives, features and advantages of the invention will be more readily understood upon consideration of the following detailed description of the invention taken in conjunction with the accompanying drawings.

### BRIEF DESCRIPTION OF THE DRAWINGS

FIG. 1 is a schematic diagram showing six server computers adapted to be coupled to an Intermediary Provisioning Server (IPS), according to an embodiment of the present invention.

FIG. 2 is a schematic diagram showing an example of an initial Marketplace vendor registration process, according to an embodiment of the present invention.

FIG. 3 is a schematic diagram showing an example of a process, after the initial scenario of FIG. 2, which may be taken by a marketplace server to provision a solution consisting of two 3rd party vendor applications, according to an embodiment of the present invention.

FIG. 4 is a schematic diagram showing an example of a process, after the scenario of FIG. 3, which may be taken by a marketplace server to de-provisioning a 3rd party vendor application within a provisioned solution, according to an embodiment of the present invention.

### DETAILED DESCRIPTION OF PREFERRED EMBODIMENTS

An example of the structure and use of an intermediary network component, in this case an intermediary provisioning server, according to the present invention will now be explained in the context of one marketplace and two 3rd party vendors connected through the Internet; however, the present invention is not limited in scope in this respect. For example, the present invention is not limited to the Internet or to one marketplace or two 3rd party vendors. Any network would suffice and any number of marketplaces and 3rd party vendors may participate in the provisioning of any number of solutions and products.

Further, the present invention is explained in the context of a marketplace providing solution type and solution provisioning information and vendors providing product type and product provisioning information to an intermediary provisioning server; however, the present invention is not limited in scope in this respect. For example, the present invention is not limited to only a marketplace providing solution type and solution provisioning information. Vendors may also provide solution type and solution provisioning to an intermediary provisioning server.

A network structure and the method of its use for distributing and maintaining provisioning information between a network marketplace and one or more vendors for the purpose of registering, installing and configuring solutions and products is provided. A marketplace (using, for example, a server machine) first transmits to an intermediary provisioning server a first message including a list of solution types, product types and provisioning requirements. Next one or more 3rd party vendors each transmit a message to said intermediary server containing a list of supported product types and provisioning requirements for each. Upon purchase intent by a customer of a solution within said marketplace, said marketplace requests solution, product and provisioning information from said intermediary provisioning server and presents said information to the client device used by said customer. Next said customer commits to purchase an instance of said solution providing required customer supplied provisioning information. Next, said marketplace transmits a message to said intermediary server instructing said server to provision said solution and providing customer and server supplied provisioning values as part of said message. Next, said intermediary provisioning server determines the set of responsible provisioning servers and instructs all servers in said set to provision their respective solution parts for said solution instance using said customer and server supplied provisioning information. Upon completion of said provisioning of all parts of said solution, said intermediary provisioning server responds to said marketplace providing the completed provisioning details for said solution instance for said customer.

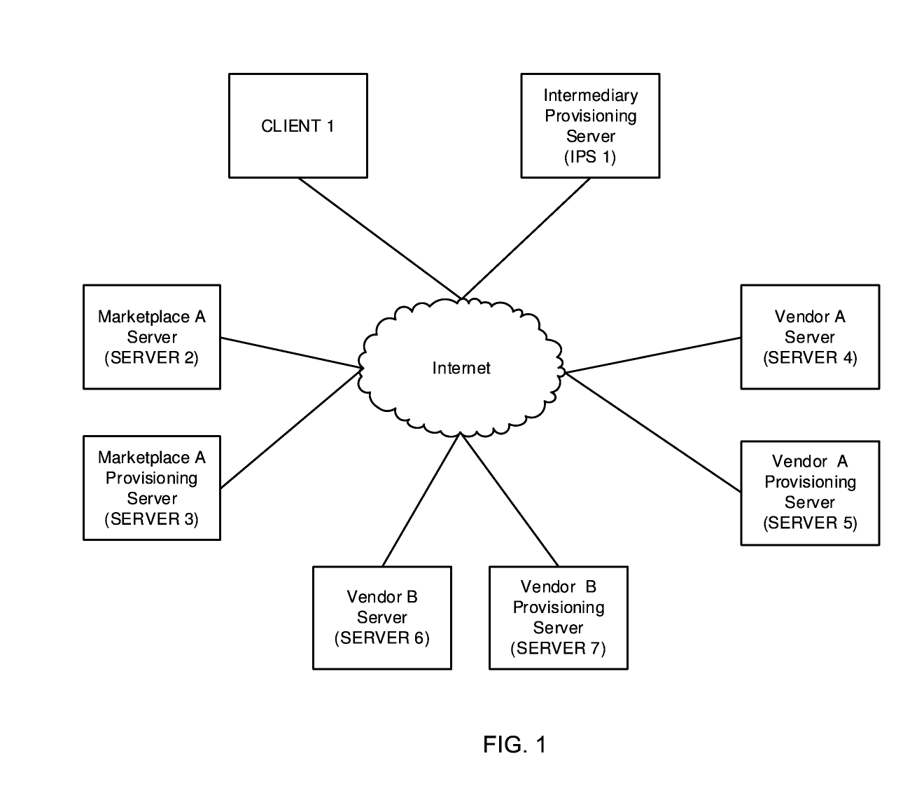

FIG. 1 is a schematic diagram showing one client computer adapted to be coupled to 1 marketplace server computer. FIG. 1 also shows 7 server computers, including said marketplace server computer adapted to be coupled to an Intermediary Provisioning Server (IPS 1), according to an embodiment of the present invention. In this context, connection refers to a communicative relationship among entities such as an Internet connection. Each of servers 2, 3, 4, 5, 6 and 7 is able to transmit messages to IPS 1 and receive messages from IPS 1. For example, each of the computing devices CLIENT 1, IPS 1, and SERVER 2 through SERVER 7 may use their respective processors (in a known manner) to execute software such as Microsoft Winsock application programming interface (API). Microsoft Winsock API uses transmission control protocol/Internet protocol (TCP/IP) to divide messages into packets and send the packets from software on one client or server to software on another client or server via a network such as the Internet.

To illustrate an embodiment of a method according to the present invention, assume the following initial conditions: 1) Marketplace A has a list of solution types, including but not limited to solution type ST1, which can be offered for sale through said marketplace. 2) Each solution type, including said ST1, has a set of registration requirements which must be specified in order to offer a solution for sale in said marketplace. 3) For each solution type, said set of registration requirements include, but are not limited to, the set of product types comprising said solution and 4) for each product type said set of registration requirements include, but are not limited to, the number of required product instances, the number of optional product instances and the number of initial product instances. 5) Further, for each said solution, said marketplace has a set of required registration fields for each product type in said solution. 6) Further, Vendor A and Vendor B both have interest in offering their respective products within solution of type ST1 of said Marketplace A. 7) Vendor A has interest in offering product PA1 for sale in said Marketplace A. Product PA1 is of product type PT1. Vendor B has interest in offering products PB1 and PB2 for sale in said Marketplace A. Product PB1 is of product type PT1 and product PB2 is of product type PT2.

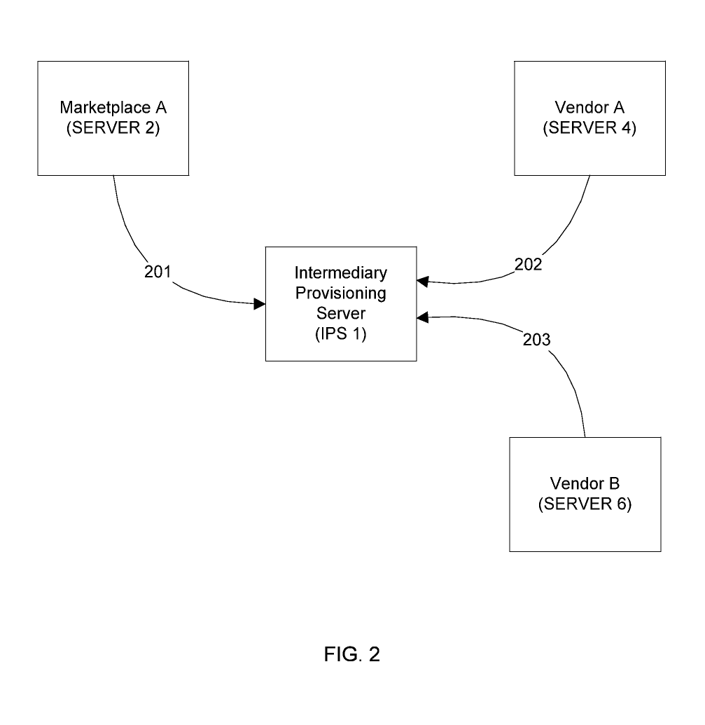

Events after these initial conditions are sequentially illustrated using the numbered arrows in FIG. 2. In 201, Marketplace A first transmits to IPS 1 the following information: the list of solution types available in said marketplace (comprised of ST1 in this example); for each solution type, a list of required product types (comprised of PT1 in this example), a list of optional product types (comprised of PT2 in this example), and a list of zero or more provisioning server network address endpoint(s) associated with said solution type (comprised of network endpoint address for SERVER 3 in this example); for each said product type: 1) a sequence number identifying the position of said product type respective to other product types in said solution type (comprised of 1 and 2 for PT1 and PT2 respectively in this example), 2) a list of required registration fields (comprised of “product title” and product “product description” for both PT1 and PT2 in this example), 3) a list of optional registration fields (empty in this example), 4) a list of required provisioning fields (comprised of “domain name” for PT1, and “customer service telephone” and “support type” for PT2 in this example), 5) a minimum, maximum and initial quantity (comprised of 1,1,1 and 0, 1, 1 for PT1 and PT2 respectively in this example).

In 202, Vendor A transmits to IPS 1 the following information: the list of products (comprised of PA1 in this example) and associated product types (comprised of PT1 in this example) as well as the product title for PA1 (“PA1 title” in this example) and description for PA1 (“PA1 description” in this example); a list of required Vendor A provisioning fields for PA1 (comprised of “administrative e-mail” and “administrative contact” in this example) and a list of optional Vendor A provisioning fields (comprised of “custom instructions” in this example); pricing information for PA1; the network endpoint address of Vendor A Provisioning Server (SERVER 5 in this example).

In 203, Vendor B transmits to IPS 1 the following information: the list of products (comprised of PB1 and PB2 in this example) and associated product types (comprised of PT1 and PT2 respectively in this example) and the product titles for PB1 and PB2 (“PB1 title” and “PB2 title” respectively in this example) and descriptions for PB1 and PB2 (“PB1 description” and “PB2 description” respectively in this example); a list of required Vendor B provisioning fields for PB1 (comprised of “contact e-mail” and “contact phone” in this example) and a list of optional Vendor B provisioning fields for PB1 (comprised of “preferred contact method” in this example); pricing information for PB1; a list of required Vendor B provisioning fields for PB2 (comprised of “service level agreement” in this example) and a list of optional Vendor B provisioning fields for PB2 (comprised of “lost business insurance amount” in this example); pricing information for PB2; the network endpoint address of Vendor B Provisioning Server (SERVER 7 in this example).

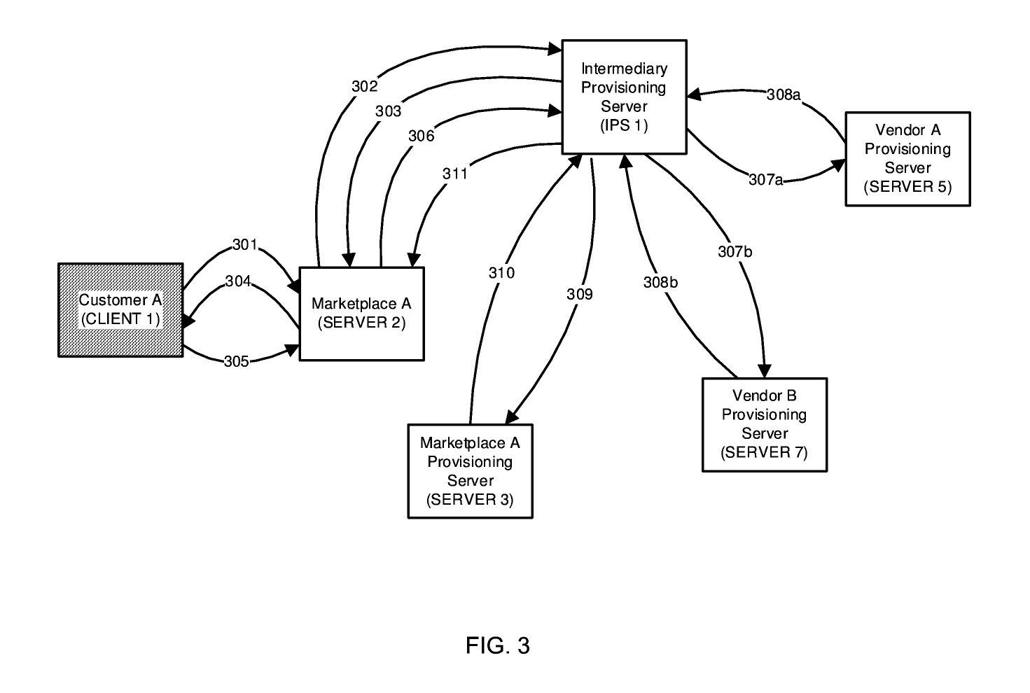

Events after the solution and product registration steps shown in FIG. 2 are sequentially illustrated using the numbered arrows in FIG. 3. In 301, Customer A (using CLIENT 1) first transmits a message to SERVER 2 indicating interest in purchasing a solution of type ST1. In 302, upon receiving message 301, SERVER 2 transmits a message to IPS 1 requesting vendor product and provisioning information for all products of type PT1 and all products of type PT2. In 303, IPS 1 responds with the following information: PA1 and its associated information including title for PA1 (“PA1 title”), description for PA1 (“PA1 description”), product type for PA1 (PT1 in this example), required provisioning field list for PA1 (comprised of “administrative e-mail” and “administrative contact” in this example), and optional provisioning field list for PA1 (comprised of “custom instructions” in this example); PB1 and its associated information including title for PB1 (“PB1 title” in this example), description for PB1 (“PB1 description” in this example), product type for PB1 (PT1 in this example), required provisioning field list for PB1 (comprised of “contact e-mail” and “contact phone” in this example), and optional provisioning field list for PB1 (comprised of “preferred contact method” in this example); PB2 and its associated information including title for PB2 (“PB2 title” in this example), description for PB2 (“PB2 description” in this example), product type for PB2 (PT2 in this example), required provisioning field list for PB2 (comprised of “service level agreement” in this example), and optional provisioning field list for PB2 (comprised of “lost business insurance amount” in this example).

In 304, upon receiving message 303, SERVER 2 formats a message appropriate for CLIENT 1 containing information about solution type ST1, including information contained in message 303.

Upon receipt of message 304, Customer A (using CLIENT 1) selects to purchase a solution of type ST1 comprised of one instance each of product PA1 and PB2. In 305, said Customer A (using CLIENT 1) specifies and transmits to SERVER 2 purchase information for a solution of type ST1, including but not limited to customer specific values for required and optional provisioning fields of ST1 (comprised of values for “customer service telephone”, “support type”), of PA1 (comprised of values for “administrative e-mail”, “administrative contact”, “custom instructions”) and of PB2 (comprised of values for “service level agreement”, “lost business insurance amount”).

In 306, upon receipt of message 305, SERVER 2 transmits to IPS1 a message containing said customer specific values for required and optional provisioning fields of ST1, PA1, and PB2. Upon receipt of message 306, IPS 1 generates a globally unique provisioning id, here forth known as GUPID, and associates it using durable storage with the provisioning of a new solution instance S1 of type ST1 for Customer A.

In 307a, upon receipt of message 306, IPS 1 transmits a message to Vendor A Provisioning Server (SERVER 5) containing said GUPID along with a list of required and optional provisioning fields and their specific values contained in said message 306 as pertaining to provisioning of product PA1 (comprised of values for “administrative e-mail”, “administrative contact”, “custom instructions”) for Customer A.

Upon receipt of message 307a, Vendor A Provisioning Server (SERVER 5) uses the information contained in message 307a to provision a product instance of PA1 for Customer A. In 308a, upon completion of said provisioning, SERVER 5 responds to message 307a by transmitting a message containing said GUPID along with information indicating completion status of said provisioning for said product instance PA1 for Customer A.

In 307b, upon receipt of message 306, IPS 1 transmits a message to Vendor B Provisioning Server (SERVER 7) containing said GUPID along with a list of required and optional provisioning fields and their specific values contained in said message 306 as pertaining to provisioning of product PB2 (comprised of values for “service level agreement”, “lost business insurance amount”) for Customer A.

Upon receipt of message 307b, Vendor B Provisioning Server (SERVER 7) uses the information contained in message 307b to provision a product instance of type PB2 for Customer A. In 308b, upon completion of said provisioning, SERVER 7 responds to message 307b by transmitting a message containing said GUPID along with information indicating completion status of said provisioning for said product instance PB2 for Customer A.

In 309, upon receipt of both messages 308a and 308b, IPS 1 transmits a message to Marketplace A Provisioning Server (SERVER 3) containing said GUPID along with said provisioning information from messages 308a and 308b as well as a list of required and optional provisioning fields and their specific values contained in said message 306 as pertaining to provisioning of solution instance S1 (comprised of values for “customer service telephone”, “support type”) of type ST1 for Customer A.

Upon receipt of message 309, Marketplace A Provisioning Server (SERVER 3) uses the information contained in message 309 to provision solution instance S1 of type ST1 for Customer A. In 310, upon completion of said provisioning, SERVER 3 responds to message 309 by transmitting a message to IPS 1 containing said GUPID along with information indicating completion status of said provisioning for solution instance S1 for Customer A.

In 311, upon receipt of message 310, IPS 1 transmits a message to Marketplace A (SERVER 2) containing said GUPID along with said provisioning status contained in message 310.

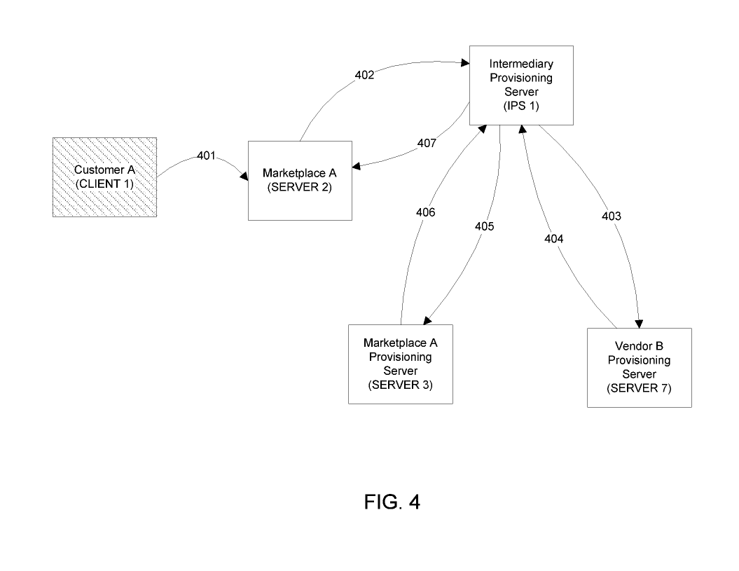

FIG. 4 illustrates an optional provisioning change which may occur after the initial provisioning steps as shown in FIG. 3 have occurred. Steps in FIG. 4 are sequentially illustrated using the numbered arrows. In 401, Customer A (using CLIENT 1) first transmits a message to SERVER 2 indicating desire to drop product instance PB2 from solution instance S1.

Upon receipt of message 401, in 402, Marketplace A (SERVER 2) transmits a message to IPS 1 containing the GUPID uniquely identifying said provisioning of solution instance S1 for Customer A along with information indicating the desire to de-provision product instance PB2 contained in said solution instance S1.

Upon receipt of message 402, in 403, IPS 1 transmits a message to Vendor B provisioning server (SERVER 7) containing said GUPID and indicating intent to de-provision product instance PB2 within solution instance S1 for Customer A.

Upon receipt of message 403, Vendor B Provisioning Server (SERVER 7) uses the information contained in message 403 to de-provision product instance PB2 for Customer A. In 404, upon completion of said de-provisioning, SERVER 7 responds to message 403 by transmitting a message containing said GUPID and de-provisioning status for product instance PB2 for Customer A.

Upon receipt of message 404, in 405, IPS 1 transmits a message to Marketplace A Provisioning Server (SERVER 3) containing said GUPID and indicating the completed de-provision of product instance PB2 within solution instance S1 for Customer A.

Upon receipt of message 405, Marketplace A Provisioning Server (SERVER 3) uses the information contained in message 405 to remove product instance PB2 from the sequence of provisioned product instances contained in solution instance S1 for Customer A. In 406, upon completion of said removal, SERVER 3 responds to message 405 by transmitting a message to IPS 1 containing said GUPID along with said removal status of product instance PB2 for Customer A.

In 407, upon receipt of message 406, IPS 1 transmits a message to Marketplace A (SERVER 2) containing said GUPID and indicating the completion of de-provisioning of product instance PB2 within solution instance S1 for Customer A.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A computer system for disseminating product provisioning information provided by two or more vendors to at least one customer via a marketplace and an associated intermediary provisioning server, said system comprising:
(a) a marketplace offering at least two products for distribution to at least one customer;
(c) an intermediary provisioning server; and
(d) software recorded on a computer-readable medium enabling the intermediary provisioning server to perform the steps of:
i. receiving a message from the marketplace containing customer specific values for provisioning one or more said products requested by said customer and provided by a said vendor,
ii. in response to said message, transmitting a message to said vendor including a globally unique provisioning identification code, and
iii. receiving from said vendor a message containing said globally unique provisioning identification code and a message indicating a provisioning completion status.

2. The system of claim 1 wherein said software enables the intermediary provisioning server to perform the additional subsequent step of receiving a message from the marketplace including said globally unique provisioning identification code and information indicating a desire to de-provision an associated product, and, in response to said message, transmit a message to an appropriate vendor.

3. The system of claim 1 wherein said software enables said intermediary provisioning server to associate said globally unique provisioning identification code with a durable storage capacity.
